(19) United States
(12) Patent Application Publication
(10) Pub. No.: US 2012/0258028 A1
(43) Pub. Date: Oct. 11, 2012

(54) TEST TUBE SUPPORT APPARATUS

(76) Inventor: Alex Hicks, Concord, NH (US)

(21) Appl. No.: 13/439,614

(22) Filed: Apr. 4, 2012

Related U.S. Application Data
(60) Provisional application No. 61/473,255, filed on Apr. 8, 2011.

(51) Int. Cl. B01L 9/06; B23P 17/00

(52) U.S. Cl. 422/562; 29/557

(57) ABSTRACT

A support stand for test tubes and more particularly to an easy to manufacture and economical test tube stand which facilitates handling of test tubes and samples contained therein in a field environment, particularly in a rugged field environment where the test tubes and samples are subject to significant movement and instability for example on a boat or truck during procurement and initial analysis of the sample.

This application claims the benefit of U.S. provisional application No. 61/473,255 filed Apr. 8, 2011 and entitled Test Tube Support Apparatus (Attorney Docket No. HICALE P01AUSPR), which is hereby incorporated herein by reference in its entirety.

### FIELD OF THE INVENTION

The present invention relates to a support stand for test tubes and more particularly to an easy to manufacture and economical test tube stand which facilitates handling of test tubes and samples contained therein in a field environment, particularly in a rugged field environment where the test tubes and samples are subject to significant movement and instability for example on a boat or truck during procurement and initial analysis of the sample.

### BACKGROUND

Test tube holders, supports and trays are conventionally known and used throughout the scientific, medical and academic community for holding test tubes necessary for collection and testing of solids, gasses and fluids. Almost any material for that matter can be sampled and maintained in a test tube for research, collection and testing. Test tubes themselves are generally made of glass and are substantially fragile and, unlike other lab equipment such as a beaker or Erlenmeyer flask, cannot generally stand or support themselves on their own accord. Generally, a test tube holder or support is provided in a lab environment to hold the test tubes and there are numerous types of test tube holders and supports depending on the specific test tube and analysis being done.

Test tube holders and supports are manufactured from many different materials such as plastic, metal or wood, and sometimes even cardboard. The known test tube supports are generally feasible and useful only in a lab environment where equipment and the surrounding environment is substantially stable and planar, i.e. horizontal surfaces such as heavy lab tables and counters are available to support them. However when scientists and engineers are in a field environment, on boats in particular, and also on moving vehicles such as trucks the handling and storage of such test tubes is not so easily accomplished. Furthermore, many of these test tubes supports and holders are expensive and difficult to manufacture and are not conducive by their structure and arrangement to storage or transportation on moving vehicles such as boats and trucks.

Up until now test tube supports have been fabricated generally in either one or two pieces by molding, metal stamping, machining etc. These devices exist in a variety of configurations for instance with a upper support portion having a bore slightly larger than the test tube diameter for maintaining the test tube in a desired vertical position, and a lower support portion which maintains the test tube in desired horizontal position. The lower support portion generally includes a floor for supporting a base or bottom of the test tube and the lower support portion is itself supported usually directly in a lab on a lab desk or countertop. The bore is sized for accommodating differing test tube diameters, and can vary widely to accommodate various sizes of such test tube which are generally cylindrical in structure.

A disadvantage of prior art test tube holders is that they are not particularly stable, and that the combined centers of gravity of the stand and test tube are positioned substantially spaced from the base of the holder so that the stand and test tube can be easily knocked over. Moreover the known manufacturing methods are relatively complex for such a simple device and this leads to significant costs which cannot be as easily absorbed by research laboratories and academic facilities which rely on public and private funding for their research. The difficulty with such prior art devices from both a structural and manufacturing standpoint is for example shown with reference to U.S. Pat. No. 5,996,818 to Boje et al., where the storage rack disclosed therein is in fact hollow and comprised of a number of different pieces including a two-piece housing 12 supporting a number of stacked plates 38-46, best shown in FIGS. 2-4 of Boje et al. Storage and support devices such as this also fail to provide for ample viewing of the specimen in the test tube where the specimen is below the top of the support device. This is of particular importance with respect to the researcher or student being able to see the reaction, specimen or whatever is inside the test tube.

### SUMMARY OF THE INVENTION

It is therefore an object of the present invention to provide an improved test tube holder for storage of specimen test tubes.

It is another object to provide a test tube holder which has a cavity for receiving and retaining specimen test tubes and an additional bore which facilitates visualization of the specimen inside the test tube.

A further object of the present invention is to define a testing or support holder which is substantially solid except for the receiving cavity and the viewing aperture permitting viewing of 360° of the specimen near the bottom of the test tube while maintaining a center of gravity closer to the base of the holder than the top surface.

It is yet another object of the present invention to provide a test tube support rack where the viewing aperture and the receiving cavity are substantially the same size as the test tube to be supported therein and the center of gravity of the support rack is adjacent the base of the support rack.

It is yet another object of the present invention to provide a method of simply manufacturing a testing support rack which is inexpensive, economical and yet provides for support and viewing of the specimen in the test tube on an unstable, moving vehicle.

The present invention is directed to a test tube support for supporting at least a test tube comprising a substantially solid housing comprising a support cavity and a viewing aperture; and wherein the support cavity is formed partially through the block extending from a top surface of the housing to a point spaced from a bottom surface of the housing and the viewing aperture extending from one of a front face of the housing through to a back face of the housing and intersecting in a substantially perpendicular manner with the support cavity.

The present invention is further directed to a method of making a test tube support comprising the steps of providing a substantially solid housing for receiving the test tube by forming a support cavity and a viewing aperture in the housing wherein the support cavity is formed partially through the block extending from a top surface of the housing to a point spaced from a bottom surface of the housing and the viewing aperture extending from one of a front face of the housing through to a back face of the housing and intersecting in a substantially perpendicular manner with the support cavity.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIGS. 1A and 1B is a perspective view of a testing support rack of the present invention;

FIG. 2 is a front elevation of view of the testing support rack of the present invention;

FIG. 3 is a top planner view of view of the testing support rack of the present invention;

FIG. 4 is bottom planner view of the testing support rack of the present invention;

FIGS. 5A and 5B is a perspective view of the test tube support rack of the present invention supporting a test tube within the support aperture; and

FIGS. 6A and 6B is a perspective view of the test tube support rack of the present invention for supporting a plurality of test tubes.

### DETAILED DESCRIPTION OF THE PREFERRED EMBODIMENTS

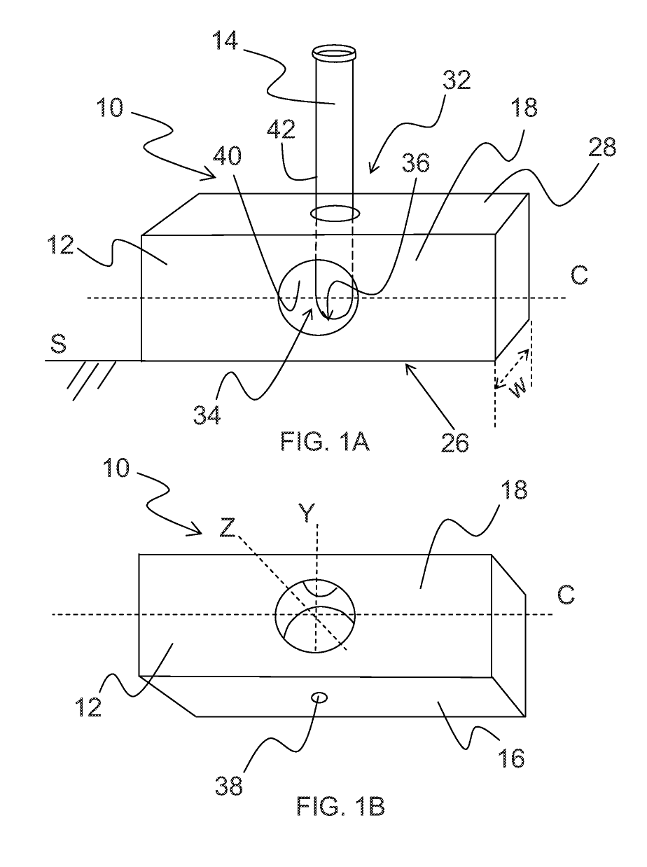

Referring now to the drawings in which similar corresponding parts are identified with the same reference and more particularly to FIGS. 1A and 1B, the test tube holder 10 of the present invention is designated by a housing 12 for supporting at least a single test tube 14 of a predetermined diameter. It is to be appreciated that the housing 12 could support a plurality of test tubes as well even test tubes having the same or different diameters. Besides test tubes, it is to be appreciated that housing 12 can support vials (not shown) in a similar manner as well. Vials are understood in the art to have a flat bottom and a threaded or snap-on cap, whereas test tubes have rounded bottoms and are usually sealed with a plug. The dimensions and structure of the test tube holder 10 are of significant importance here, where as shown in the present embodiment, the housing 12 is substantially rectangular, although other potential shapes such as a square, or circular could also be used. The housing 10 is provided with a planar base 16 which defines the basic shape of the holder 10 shown here as rectangular. It is important that substantially all of the surface area of the planar base 16 be in contact with the support surface S upon which the housing 12 is supported. This creates an important frictional contact between the base and the support surface S so that the housing 12 does not easily slide or tip over relative to the support surface.

The housing 12 is generally a substantially solid structure and further as shown in the present embodiment of FIGS. 1-4 having a front face 18 and a back face 20 along with two opposing side faces 22, 24. The front and back face 18, 20 have a length l and a height h, and the side faces 22, 24 define a width w and the same height h of the test tube holder 10. It is again important that the lower most edge 26 of the housing 12 as defined by the length l and width w be essentially co-planar with the base 16 of the housing 10 and substantially parallel along the entire length l and width w with the support surface S supporting the test tube holder 10. This structure provides for the contiguous lower most edge 26 of the housing 12 essentially in constant contact with the support surface S and thus resistant to tipping over, i.e. becoming inadvertently non-coplanar with the support surface S upon which the test tube holder 10 is placed.

The housing 12 has a top surface 28 which is substantially coplanar with the bottom surface 30, and generally spaced a distance defined by the height h from the bottom surface 30. This coplanar structure provides for a uniform and consistent mass distribution throughout the entirety of the housing 12 which again improves the stability of the housing 12 on any support surface S upon which the housing 12 rests. The only portion or portions of the housing 12 which are not substantially solid are the one or more support cavities 32 and the viewing aperture 34 formed in the housing 12. It is to be appreciated that the volume(s) defined by the support cavity 32 and the viewing aperture 34 are substantially smaller than the respective volume of the solid portions of the housing 12 which lends a substantial mass and weight to the test tube holder 10 to facilitate stability of the device.

The support cavity 32 is shown clearly in FIG. 1B showing the cavity extending only partially, i.e. not completely through the housing. The terminus 36 of the cavity is well below the centerline C of the housing 12 and spaced from the bottom surface 30 so that the test tube 14 can be supported and protected within the support cavity 32. A drain hole 38 can be formed from the terminus of the cavity 32 through to the bottom surface 30 to facilitate drainage of any fluid that might enter or be splashed into the cavity 32. The drain hole 38 would have a substantially smaller diameter than the cavity 32 so that the test tube 14 does not go past the terminus of the cavity 36 and only excess fluid can drain out. The drain hole 38 can even be offset from the central axis Y of the cavity 32 so that where a test tube 14 having a rounded base is used, the drain hole 38 is not blocked by the base of the test tube 14. Alternatively, the drain hole 38 could be used to define a passage for a securing screw to secure the housing to support surface.

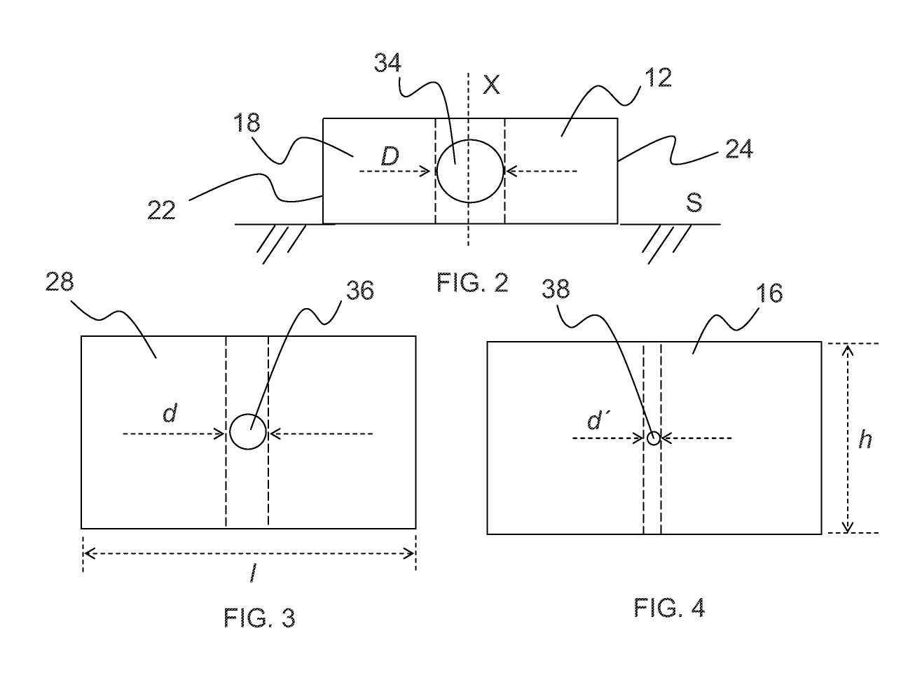

The viewing aperture 34 extends entirely through the housing 12 and intersects substantially perpendicularly with the support cavity 32. The viewing aperture 34 is defined about a viewing aperture axis X as seen in FIG. 2 which intersects with the support cavity axis Y so that the passages are generally centrally aligned which facilities viewing of a significant portion of the test tube 14 and its contents when it is inserted in the support cavity 32. The viewing aperture 34 may be the same or different diameter then the support cavity 32, but is preferably at least the same diameter as the cavity 32 so that the entire width of the test tube 14 facing the aperture 34, and all the contents therein, can be clearly seen in the viewing aperture 34 and also that light entering the viewing aperture 34 is provided directly onto the entire width of the test tube 14 in the viewing aperture 34. A viewing aperture 34 that has a larger diameter than the cavity 32 is also contemplated so that more indirect light, in a 360 degree manner, around the test tube 14 provides for better viewing the test tube 14 and sample therein even though there is no direct aperture, light or viewing available of the portion of the test tube 14 which is not facing the aperture 34.

Another important aspect of the present invention is that there is defined by the above discussed structure a continuous substantially cylindrical sidewall surface 40 extending from the terminus of the cavity 36 all the way to the top surface 28 of the housing 12. This continuous sidewall surface 40 provides support and protection along a radial portion of the entire length of the test tube 14 situated in the cavity 32. This continuous surface ensures that with the exception of the viewing aperture portion, the test tube 14 is protected along the entire length it is inserted in the support cavity 32 and that no edges other than that defined by the aperture 32 can impact the sidewall 42 of the test tube 14 in the event that a force or shock is applied to the housing 12.

In one embodiment, any volume of the housing 12 outside of the viewing aperture 34, support cavity 32 and the drain hole 38 is solid material so that the mass of the housing 12, even with the addition of a test tube 14 and sample is maintained immediately adjacent the support surface S on which the housing 12 is situated to improve both frictional resistance between the support surface S and the housing 12 as well as a low center of gravity of the housing and test tubes 14 to prevent lateral and vertical forces from tipping the housing 12 and test tubes 14 over.

It is also to be appreciated that the nature of the disclosed embodiment being a substantially rectangular block facilitates a highly cost effective process for manufacturing of the housing 12. The housing 12 can be made from a block of stock lumber, plastic, metal or other material which is often formed, cut, shipped and sold in rectangular and square cross-section. Cylindrical dowels with a round cross-section are also generally a stock lumber and available in other materials as well. The ability to use stock off-the-shelf material is critical to the employment, use and cost of the present invention. A piece of lumber, for example a 2×4, having a rectangular approx. 2 inch×4 inch cross-section facilitates any number of such blocks for housings, of any desired length, being efficiently manufactured by a single cutting operation. Each block would require at most only a single cut from the stock lumber, and a plurality P of blocks can even be cut from a stock piece of lumber where the number of cuts to form P blocks is actually P−1 cuts. This is because there is always a remainder of the stock material as it is sequentially cut that can be used as a block to manufacture a housing 12 where proper measurement is made. For instance, a 4 ft. piece stock material can be cut into eight (8) 6″ blocks with 7 cuts. This of course is a significant time, cost and energy savings in any manufacturing process which can lower the final cost of the end product to the consumer. It should be appreciated that the formation of the viewing aperture 34, support cavity 32 as well as the drain hole 38 described below, could be formed in the stock material prior to the cutting and separation of the stock material into individual housings 12 or blocks.

The housing 12 is then formed from the block cut from the stock material by forming the viewing aperture 34, the support cavity 32 and, if needed, the drain hole 38. In order to support a test tube 14 the support cavity 32 is drilled about an axis Y from the top surface 28 of the housing 12 and extending through the housing 12 towards the bottom surface 30, but does not communicate entirely through the housing 12, and the terminus 36 is formed prior to the drill reaching the bottom surface 30. The drain hole 38 which might extend from the terminus 36 of the support cavity 32 through to the bottom surface 30 may be formed simultaneously with the same drill, or by another drill apparatus and may or may not be formed co-linear with the support cavity 32 but may be formed in any manner through the bottom surface 30.

The viewing aperture 34 is drilled or otherwise formed entirely through the housing 12 from the front face 18 of the housing 12 to the back face 20 of the housing 12 along the viewing aperture axis X so that the aperture communicates with and traverses the supporting cavity. The viewing aperture 34 intersects the support cavity 32 substantially perpendicularly so that the respective axes intersect at 90 degrees, and the aperture 34 extends entirely between the front and back face 18, 20 allowing light to pass all the way through the aperture 34. It is to be appreciated that generally these diameters of the aperture 34 and cavity 32 may be roughly the same however they may of course be of differently sized as well. In general the respective axes of the support cavity 32 and viewing aperture 34 are perpendicularly aligned and intersecting along a longitudinal axis of the housing 12.

It is also to be appreciated that the viewing aperture 34, support cavity 32 and drain hole 38 may be formed in either order, or even substantially simultaneously and formed by known material removal techniques such as by drilling, lasers, burning, punching or other known material removal apparatus and methods. The support cavity 32 is formed centrally, i.e. evenly spaced between the front and back faces 18, 20 of the housing 12 so that the moment arm of the housing 12 having a test tube 14 therein about the front and back face 18, 20 is the same, essentially requiring an equal minimum tipping force to knock the housing 12 and test tube 14 over either the front face 18 or the back face 20. On the other hand, the viewing aperture 34 need not be formed with the viewing aperture axis X aligned at the centerline of the front face 18 as shown in FIG. 2. The viewing aperture 34 may be formed anywhere along the height h of the front and back faces 18, 20 so that a sample or reaction within a desired part of the test tube 14 can be observed. It may also be that more than one viewing aperture 34 is formed for each supporting cavity 32 and that a viewing aperture 34 may also intersect with the top surface 28 of the housing 12.

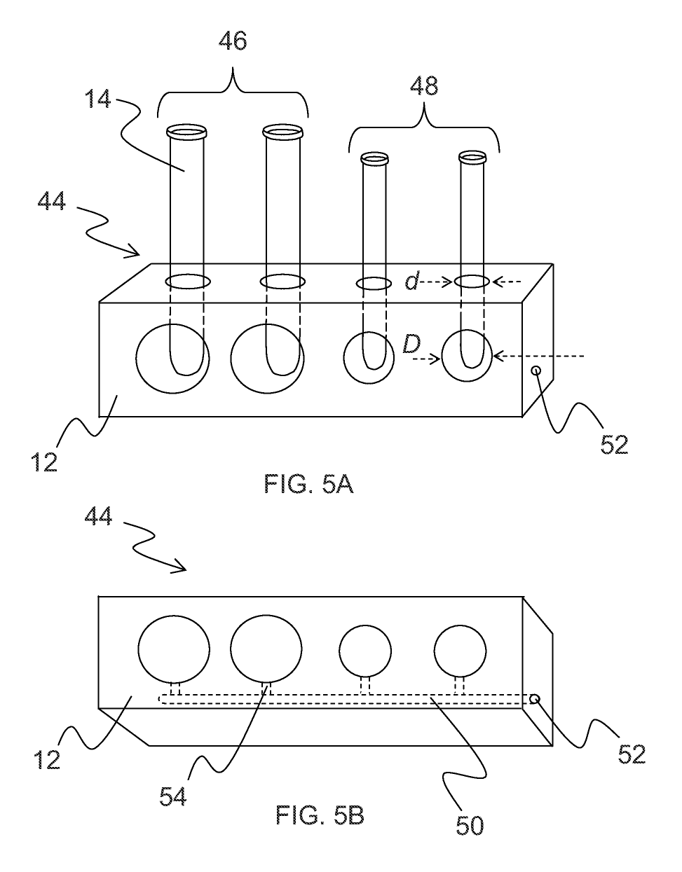

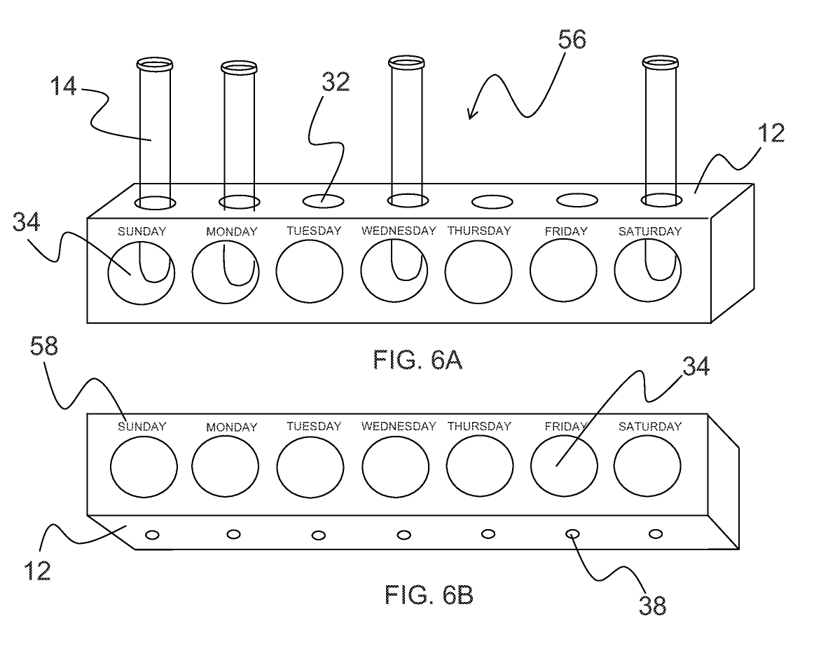

It is to be appreciated that a single housing may contain a plurality of support cavities formed therein and a plurality of respective intersecting viewing apertures so that a number of test tubes and samples may be placed side-by-side. As shown in FIGS. 5A and 5B, a test tube holder 44 may be formed with a plurality of viewing apertures 34 and support cavities 32 formed in the housing 12. A first set of support cavities 46 may be of a larger diameter D than a second set of support cavities 48 having a smaller diameter d to support test tubes 50, 52 of different sizes. The housing 12 may be formed with a single drain channel 50 formed within the housing 12 below the terminus of each of the support cavities 36. The drain channel 50 terminating at a drain hole 52 on a side surface of the housing 12. A connecting channel 54 smaller than the diameter of the support cavity 32 may be formed to connect each support cavity 32 to the drain channel 50. Alternatively, the drain channel 50 may be drilled directly through a first or second side face 22, 24 and through each support cavity 32. As shown in FIGS. 6A and 6B, a test tube holder 54 may be formed with each support cavity 32 appropriately labeled 56 or having a label holder (not shown) to easily identify the contents or collection time of the test tube sample.

In this manner a sturdy, durable and stable test tube holder is quickly and inexpensively manufactured in a single block of material. This same process could be used to form a round test tube holder having a single cylindrical outer wall and a top and bottom surface with one or more support cavities depending from the top surface. No matter what shape the housing takes, with this these several simple and efficient manufacturing steps and materials a complete stable test tube holder for use in a field environment is now prepared.

The invention has been described in detail with particular reference to certain preferred embodiments thereof, but it will be understood that variations and modifications can be effected within the spirit and scope of the invention.

I/We claim:

1. A test tube support for supporting at least a test tube comprising:
a substantially solid housing comprising;
a support cavity and a viewing aperture; and
wherein the support cavity is formed partially through the block extending from a top surface of the housing to a point spaced from a bottom surface of the housing and the viewing aperture extending from one of a front face of the housing through to a back face of the housing and intersecting in a substantially perpendicular manner with the support cavity.

2. The test tube support as set forth in claim 1 wherein the bottom surface of the housing is a contiguous substantially planar surface for creating a friction engagement with a supporting surface.

3. The test tube support as set forth in claim 1 wherein the viewing aperture is substantially the same diameter as a diameter of the support cavity.

4. The test tube support as set forth in claim 1 wherein the viewing aperture is bounded by a contiguous sidewall extending entirely through the housing.

5. The test tube support as set forth in claim 4 wherein the contiguous sidewall of the viewing aperture forms a portion of a sidewall of the support cavity.

6. The test tube support as set forth in claim 5 wherein the contiguous sidewall of the viewing aperture forms a portion of a bottom of the support cavity in the housing.

7. The test tube support as set forth in claim 6 wherein a drain hole having a smaller diameter relative to the diameter of the support cavity is formed extending between the bottom of the support cavity and the bottom surface of the housing.

8. The test tube support as set forth in claim 6 wherein at least a portion of the sidewall of the support cavity extends contiguously from the bottom of the support cavity to a top opening of the support cavity.

9. The test tube support as set forth in claim 8 wherein the top opening of the support cavity is defined in and planar aligned with the top surface of the housing.

10. A method of making a test tube support comprising the steps of:
providing a substantially solid housing for receiving the test tube by forming a support cavity and a viewing aperture in the housing wherein the support cavity is formed partially through the block extending from a top surface of the housing to a point spaced from a bottom surface of the housing and the viewing aperture extending from one of a front face of the housing through to a back face of the housing and intersecting in a substantially perpendicular manner with the support cavity.

11. The method of making a test tube support as set forth in claim 10 further comprising the step of providing the bottom surface of the housing as a contiguous substantially planar surface for creating a friction engagement with a supporting surface.

12. The method of making a test tube support as set forth in claim 10 further comprising the step of forming the viewing aperture with substantially the same diameter as a diameter of the support cavity.

13. The method of making a test tube support as set forth in claim 10 further comprising the step of bounding the viewing aperture by a contiguous sidewall extending entirely through the housing.

14. The method of making a test tube support as set forth in claim 13 further comprising the step defining the contiguous sidewall of the viewing aperture as a portion of a sidewall of the support cavity.

15. The method of making a test tube support as set forth in claim 14 further comprising the step forming the contiguous sidewall of the viewing aperture as a portion of a bottom of the support cavity in the housing.

16. The method of making a test tube support as set forth in claim 15 further comprising the step providing a drain hole having a smaller diameter relative to the diameter of the support cavity extending between the bottom of the support cavity and the bottom surface of the housing.

17. The method of making a test tube support as set forth in claim 15 further comprising the step of forming at least a portion of the sidewall of the support cavity extending contiguously from the bottom of the support cavity to a top opening of the support cavity.

18. The method of making a test tube support as set forth in claim 17 further comprising the step of defining the top opening of the support cavity planar aligned with the top surface of the housing.
